(19) United States
(12) Patent Application Publication
(10) Pub. No.: US 2013/0021471 A1
(43) Pub. Date: Jan. 24, 2013

(54) Reflective Surface Orientating with Multiple View Ports

(71) Applicants: Tamsyn Peronel Waterhouse, San Francisco, CA (US); Ross Koningstein, Atherton, CA (US)

(72) Inventors: Tamsyn Peronel Waterhouse, San Francisco, CA (US); Ross Koningstein, Atherton, CA (US)

(73) Assignee: GOOGLE INC., Mountain View, CA (US)

(21) Appl. No.: 13/188,266

(22) Filed: Jul. 21, 2011

(51) Int. Cl. H04N 7/18; G06K 9/00

(52) U.S. Cl. 348/139; 382/106

(57) ABSTRACT

The subject matter of this specification can be embodied in, among other things, a system that includes a reflective surface configured to reflect light to a target plane and three or more view ports that are optically connected to at least one camera, the view ports arranged in the target plane. A computing system is coupled to the camera and configured to receive image information captured by the view ports. The computing system, based on the image information and a relationship between intensity of light reflected by the reflective surface as captured by a particular view port and a distance of the particular view port to a point on the target plane that is a function of the light reflected from the reflective surface incident on or passing through the target plane, estimates a location on the target plane of the point.

### TECHNICAL FIELD

The present disclosure relates generally to orientating a reflective surface using image information from multiple view ports optically connected to one or more cameras.

### BACKGROUND

A heliostat solar energy system generally includes a number of heliostats configured to reflect sunlight into a receiver. The resulting heat can then be converted into power. Use of heliostats as a source of solar power often requires receiver temperatures of greater than 850° C., which in turn requires sunlight to be reflected from the heliostats into the receiver at high concentrations. Positioning of the reflected sunlight in the receiver greatly affects the efficiency of the solar energy system. Other systems for reflecting different types of waves other than light waves, e.g., sound waves, from a reflective surface toward a target also benefit from proper orientation of the reflective surface relative to the target, particularly if a source of the waves moves relative to the reflective surface.

### SUMMARY

In general, in one aspect, the subject matter described in this specification can be embodied in a system that includes a reflective surface configured to reflect light to a target plane and three or more view ports arranged in the target plane, the three or more view ports optically connected to at least one camera. The target plane may be virtual, or it may be physical. Each view port has a field of view configured to receive reflected light from the reflective surface. A computing system is coupled to the at least one camera and is configured to receive image information captured by the at least one camera from the three or more view ports. The computing system is further configured to, based on the image information and a relationship between intensity of light reflected by the reflective surface as captured by a particular view port and a distance of the particular view port to a point on the target plane that that is a function of light reflected from the reflective surface incident on or passing through the target plane, estimate a location on the target plane of the point. Other embodiments of this aspect include corresponding methods.

These and other embodiments can each optionally include one or more of the following features, alone or in combination. The system can further include an actuator system communicatively coupled to the computing system and configured to move the reflective surface to adjust an orientation of the reflective surface based on the estimated location on the target plane of the point as compared to a target location on the target plane.

The light can be sunlight and the reflective surface can be included in a heliostat. The system can further include a solar energy receiver, wherein the target plane is a plane that is coincident with a plane that includes an aperture of the solar energy receiver, through which the reflected sunlight passes into a solar energy receiving cavity. The reflective surface can be orientated to reflect the sunlight toward the solar energy receiver. The target plane can be a predetermined distance away from a plane coincident with the aperture and/or can be tilted at a predetermined angle relative to such a plane.

The point on the target plane can be approximately a point on the target plane where the light reflected from the reflective surface incident on or passing through the target plane is maximized in intensity. The point on the target plane can be a point corresponding to a centroid of the light incident on or passing through the plane.

The computing system that is configured to estimate the location based on the image information and the relationship can be a computing system that is configured to perform maximum likelihood estimation and/or configured to perform least squares fitting. The relationship between intensity of light reflected by the reflective surface as captured by a particular view port and a distance of the particular view port to a point on the target plane can include one or more free parameters and/or can be a power law relationship or a linear relationship.

The one or more free parameters can be constrained. A constraint on a parameter can be within a range of values most recently computed for the parameter. In a particular example, one of the free parameters can represent solar irradiance and can be constrained to a function of a measurement of the solar irradiance, e.g., direct normal irradiance (DNI) measured with an instrument. If computed values for the free parameters are not within their respective constraints, then the values can be deemed not reliable and the point is deemed not locatable.

The computing system can be further configured to, based on the image information, determine for each of the three or more view ports a representative intensity of reflected light as captured by each of the three or more view ports. Estimating the location of the point based on the image information and based on the relationship therefore can include estimating the location of the point based on the representative intensities and based on the relationship. The representative intensity of reflected light as captured by each of the three or more cameras can be a mean intensity of the image information for the reflected light, a weighted mean intensity of the image information, or otherwise determined.

In general, in another aspect, the subject matter described in this specification can be embodied in a system that includes multiple heliostats, each heliostat including a reflective surface configured to reflect sunlight to a target plane. The target plane may be virtual, or it may be physical. The system further includes three or more view ports arranged in the target plane, each view port having a field of view configured to receive reflected sunlight from the reflective surfaces of the heliostats and optically connected to a camera. The system further includes at least one camera that is optically connected to one or more of the three or more view ports and a computing system coupled to the at least one camera. The computing system is configured to receive image information from the at least one camera as captured by the three or more view ports. The computing system is further configured to identify each of the heliostats in a field of view of each of the three or more view ports. The computing system is further configured to, for each of the heliostats, based on the image information and a relationship between intensity of sunlight reflected by the heliostat as captured by a particular view port and a distance of the particular view port to a point on the target plane that is a function of sunlight reflected from the heliostat incident on or passing through the target plane, estimate a location on the target plane of the point. Other embodiments of this aspect include corresponding methods.

These and other embodiments can each optionally include one or more of the following features, alone or in combination. The systems can further include multiple actuator systems that each correspond to a heliostat. Each actuator system is communicatively coupled to the computing system and configured to move the reflective surface of its corresponding heliostat to adjust an orientation of the reflective surface based on the estimated location on the target plane of the point as compared to a target location on the target plane. The system can further include a solar energy receiver, wherein the target plane is a plane that is coincident with a plane that includes an aperture of the solar energy receiver, through which the reflected sunlight passes into a solar energy receiving cavity and wherein the reflective surfaces are orientated to reflect the sunlight toward the solar energy receiver. In other implementations, the target plane is a predetermined distance away from and/or tilted a predetermined angle from, such a plane that is coincident with the aperture of the solar energy receiver.

The point on the target plane can be approximately a point on the target plane where the sunlight reflected from the reflective surface incident on the target plane or passing through the target plane is maximized in intensity. The point on the target plane can be approximately a centroid of the light reflected from the reflective surface incident on the target plane or passing through the target plane.

The computing system that is configured to estimate the location based on the image information and the relationship can be a computing system that is configured to perform maximum likelihood estimation and/or to perform least squares fitting. The relationship between intensity of light reflected by the reflective surface as captured by a particular view port and a distance of the particular view port to a point on the target plane that comprises the centroid can include one or more free parameters and/or can be a power law relationship or a linear relationship.

The computing system can be further configured to, based on the image information and for each of the heliostats, determine for each of the three or more view ports a representative intensity of sunlight reflected from the heliostat and captured by each of the view ports. The representative intensity for each heliostat of reflected sunlight as captured by each of the three or more view ports can be a mean intensity of the image information for the reflected sunlight, a weighted mean intensity of the image information, or otherwise determined.

The systems and techniques described here may provide one or more of the following advantages. Real-time tracking information can be provided for an arbitrary number of devices with reflective surfaces, e.g., heliostats. In some implementations, a position of a heliostat's “spot” of reflected light on a target plane can be reported to decimeter scale accuracy. Tracking of the direction that a heliostat is directing light toward (i.e., the location of the “spot” on the target plane) can be independent from control of the orientation of the heliostat and can therefore be used even in the absence of a control system for the orientation of the heliostat. A variable number of view ports can be arbitrarily placed and used to implement the systems and techniques described, providing for a versatile system. The position of the spot of reflected light in the target plane can be determined without communicating with the heliostat that is responsible for the reflected light and is independent of the heliostat's construction or actuation kinematics.

The details of one or more implementations are set forth in the accompanying drawings and the description below. Other features and advantages will be apparent from the description and drawings, and from the claims.

### DESCRIPTION OF DRAWINGS

FIG. 1 is a schematic representation of a solar energy system including a solar energy receiver in a field of heliostats.

FIG. 2 is a schematic representation illustrating sunlight incident on a target plane.

FIG. 3 is a schematic representation showing an enlarged view of the target plane of FIG. 2.

FIG. 4 is a flow chart that shows an example of a process for using multiple cameras to locate reflected sunlight.

FIG. 5 is a schematic diagram of an example of a generic computer system.

### DETAILED DESCRIPTION

This document describes systems and techniques for using image information from multiple view ports that are optically connected to one or more cameras to determine the location of a spot of sunlight reflected off of a reflective surface, e.g., the mirror of a heliostat, toward a target location. The determined location can then be made available as feedback to a heliostat controller for use in aiming the reflected sunlight toward the target location, e.g., a solar energy receiver. In some implementations, multiple spots reflected by multiple heliostats (e.g., a heliostat field) may be located substantially simultaneously, and as such, this location information can be used as feedback for the substantially simultaneous control and alignment of multiple heliostats.

When heliostats are used as a source of heat (which can in turn be used as a source of power), the concentration of sunlight reflected into heat-collecting receivers can be lower than a theoretical ideal due to misalignment of the heliostat mirrors caused by errors such as difficulties detecting the orientation of the mirrors or relative position of the receiver, deformation of the mirror, or movement of the heliostat or receiver by natural causes.

For illustrative purposes, the methods and systems are described below in the context of a receiver being the target of solar rays reflected from heliostats. However, it should be understood that the methods and systems can be used in other implementations, such as when the target is not a receiver. For example, a target location may be selected that is a distance away from a receiver, such that solar rays reflected from one or more heliostats are not incident on the receiver, e.g., during periods of high solar intensity.

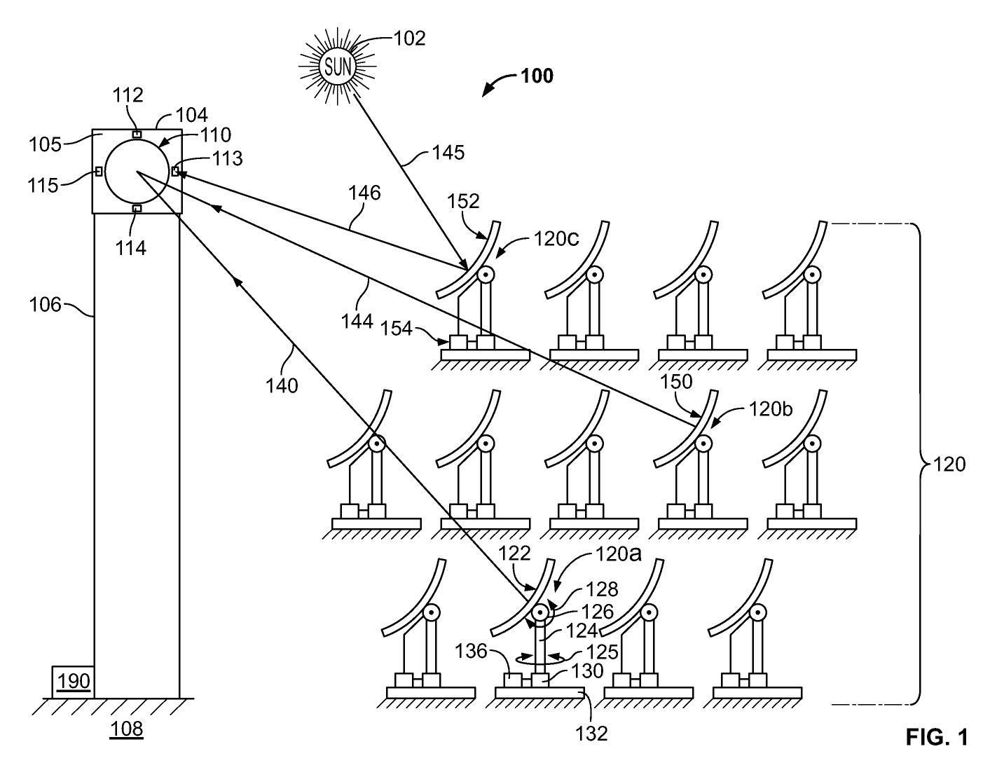

FIG. 1 is a schematic representation of a solar energy system 100 including a solar energy receiver 104 in a field of heliostats 120. The receiver 104 is mounted on a receiver tower 106 which is secured to a terrestrial surface 108. The heliostats 120 are each able to vary the direction in which their one or more reflective surfaces are pointing. Arrows 140, 144 and 146 represent some of the reflected sunlight. The receiver 104 is configured to receive solar rays reflected by the heliostats 120. The heliostats' 120 pitches and angles can be varied throughout the day to track the Sun as it appears to move across the daytime sky in order to maintain their reflective relationship with the receiver 104.

A control system can be configured to control the orientation of one or more reflective surfaces included on each of the heliostats 120 based on positions of the heliostats relative to the Sun 102. In some implementations, the control system may provide signals to a drive system to substantially control the pitch and angle of the heliostat mirrors to control the direction in which their light is reflected. In some implementations, the control system is implemented as a controller, e.g., controller 136, at each of the individual heliostats 120. That is, the heliostats 120 may include processors that substantially independently determine and control the pitch and angle of the heliostats' reflector surfaces.

Although several heliostats 120 are shown in proximity to the receiver 104, there may be more or fewer heliostats and those shown are for illustrative purposes. In the implementation shown, the receiver 104 includes an aperture 110 that is configured to receive solar rays that are reflected from the heliostats 120. Behind the aperture 110 is a receiver cavity having a surface that is configured to absorb the sunlight reflected through the aperture 110. In other implementations, the receiver 104 can include a surface (e.g., a planar surface) that is configured to receive solar rays (i.e., without an aperture and cavity) and other configurations of receiver can be used. The heat from the solar rays can be used, for example, to heat a working fluid, e.g., water, air or molten salt. By way of illustrative example, the working fluid can travel through a heat exchanger to heat water, produce steam, and then generate electricity through a turbine connected to a generator. In other examples, the heat is used to heat air or another gas. The heated gas is then expanded through the turbine, which turns a shaft to drive the generator. The electricity can be conducted to a utility grid, or some other point where the electricity can be stored, distributed or consumed. If the solar rays from one or more of the heliostats 120 are directed off-target, or even partially off-target, the heat from those heliostats is lost and the efficiency of the overall system 100 is reduced.

On a front surface 105 of the receiver 104 are four cameras 112, 113, 114, 115 positioned proximate to the circumference of the aperture 110. In the implementation shown there are four cameras, however, it should be understood that three or more cameras can be used and they can be located in different positions than those shown. It should be further understood that the three or more cameras can be replaced by three or more view ports that are optically connected to one or more cameras. That is, in operation, sunlight reflected from heliostats 120 can travel through the three or more view ports, such as through apertures in the view ports. The sunlight can further travel through a filter to reduce the intensity of the sunlight to avoid damaging of the one or more cameras that are optically connected to the view ports and other components such as a mirror and/or optics. For example, the sunlight can reflect off of a deflecting mirror and travel through optics to expand, contract, or condition the sunlight as necessary to get the optimal accuracy, prior to entry of the sunlight into the one or more cameras.

By way of illustrative example, light pipes or periscopes having their objective ends positioned within the target plane can be used with their ocular ends located elsewhere. The ocular ends can direct the light from each view port into the lens of a camera, or they can direct the light from all of the view ports into a single camera. In such an implementation, the single camera would therefore see the light captured by all of the view ports in different regions of the camera's field of view. Such a strategy can be advantageous so as to locate the camera away from the hostile environment near a solar energy receiver. As mentioned, in some implementations each view port is optically connected to its own dedicated camera. In other implementations, the view ports are optically connected to the same camera. Other configurations are possible. The one or more cameras can then produce image information including pixels having a brightness dependent on the orientation of the reflective surfaces of heliostats 120. For illustrative purposes, the methods and systems are described herein in the context of cameras positioned in a target plane, although, as discussed above, it should be understood that the cameras can be view ports that are optically connected to cameras.

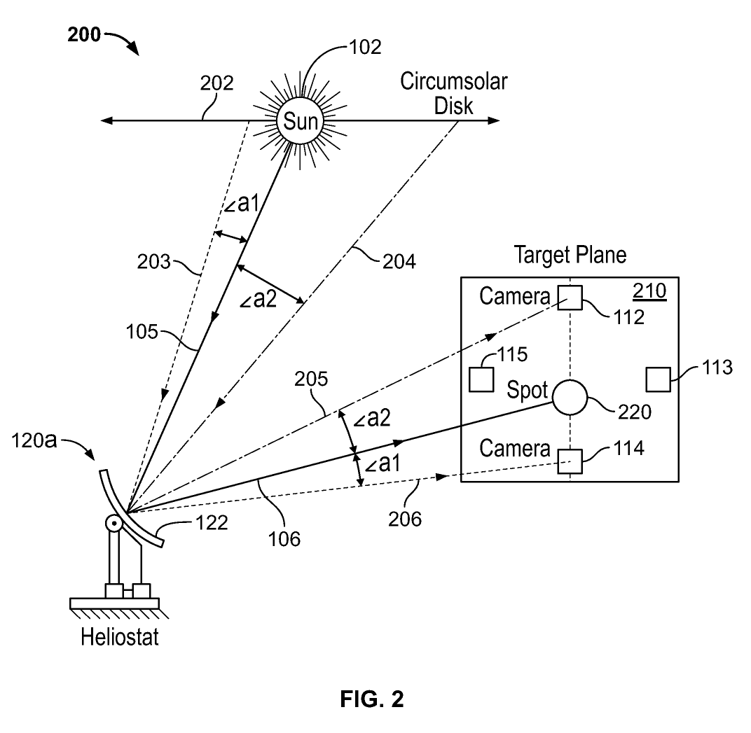

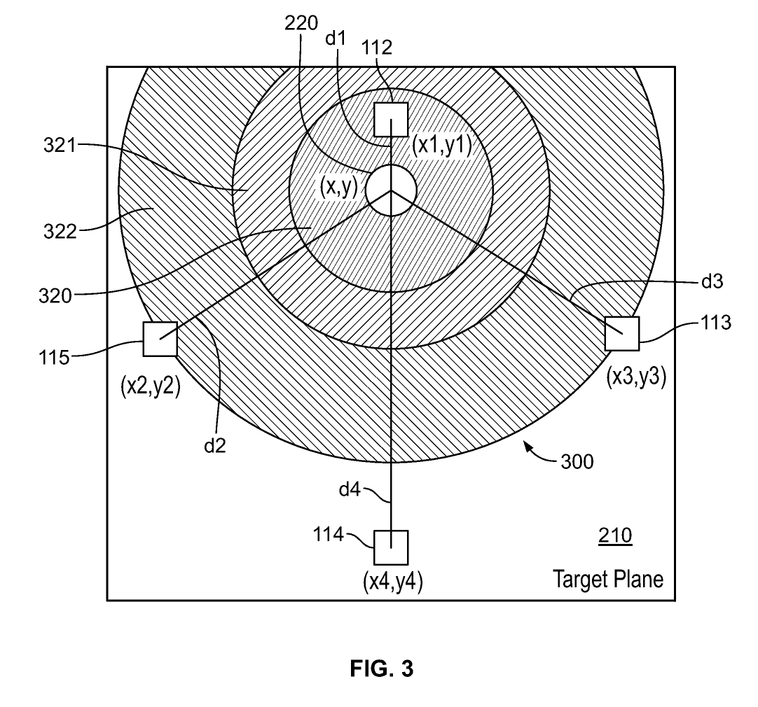

When solar rays from a heliostat, for example the heliostat 120b, are reflected toward the receiver 104 on-target, the reflected solar rays, for example the ray 144, are incident on the aperture 110. However, if a heliostat is off-target, then some or all of the solar rays reflected from the heliostat may miss the aperture 110 and spill over into the area that includes the cameras 112-115. Even if a heliostat is directed on-target, e.g., toward the center of the aperture 110, some light from either the Sun 102 or an apparent circumsolar disk present around the Sun may be reflected toward the cameras 112-115, which is described in more detail below with reference to FIG. 2 and FIG. 3.

Positioning the cameras 112-115 within the receiver cavity or within the perimeter of the aperture 110 would increase the intensity of sunlight received within the field of views of the cameras, however, in practice the temperature at such a location would be too high for the cameras 112-115. To reduce the heat the cameras 112-115 are exposed to, they can be positioned outside the perimeter of the aperture 110 as shown in FIG. 1. Additionally, in some implementations, a cooling system can be used to protect the cameras 112-115. For example, a jacket of coolant surrounding the each camera can be connected to an external liquid coolant circulation system. In some implementations, an optical filter may be disposed on each camera, the filter being adapted to reduce the flux intensity of the sunlight received in the camera to within the camera's predetermined light sensitivity range. In some implementations, filters in front of the camera can allow only light at particular wavelengths to enter the camera, while keeping the majority of the thermal energy away from the camera. In some implementations, the filters are neutral density filters. In some implementations, the cameras are remote from the region of intense sunlight and are optically connected to view ports as described above.

The reflected sunlight from the reflective surface of a heliostat, e.g., reflective surface 122 of heliostat 120a, projects a “spot” of sunlight incident on the aperture 110 of the receiver. The aperture forms a “virtual plane” through which the sunlight passes and is incident on the receiver cavity surface. Because the plane is virtual (i.e., not a physical plane), a centroid of the sunlight represents a point in the virtual plane. That is, the centroid may be approximately the center of the solar radiation reflected from the heliostat 102a passing through the virtual plane, although the solar radiation may not form a single peak intensity in the center, e.g., due to vagaries in the reflective surface. In other implementations where there is a physical plane, e.g., a planar receiver surface, then the centroid is a point where the spot of sunlight is projected onto the physical plane.

Generally, to maximize intensity of solar radiation incident on the receiver cavity surface, the centroid of the spot of sunlight as it passes through the virtual plane is centered within the aperture. However, it should be understood that in some implementations, the preferred location of the centroid of the spot of sunlight can be other than the center of the virtual plane, e.g., to generate a particular flux distribution on the receiver cavity surface or otherwise. Accordingly, to account for differing situations, there is generally a “target location” or a “desired location” within the virtual plane, which can be referred to as a target plane, at which the centroid of the spot of sunlight received from a particular heliostat should coincide. The target location can be different for different heliostats within the field, i.e., not all heliostats are necessarily aimed toward the same target location. It should be understood that generally even when a heliostat is on-target, a fraction of the reflected light may be incident outside a target area. For example, imperfections in the reflective surface of the heliostat and/or dust or other contaminants present on the surface can cause some light rays to be reflected off target, as well as circumsolar scattering discussed below. A soft edge to the focused light may also cause some light rays to be incident outside a target area.

The example heliostat 120a shown includes a mirror having the reflective surface 122, which mirror is mounted on a base member 124. The reflective surface 122 can be flat or curved for better optical performance. Moreover, the reflective surface 122 can be in the shape of a quadrilateral, e.g., a square, or it can have rounded edges, e.g., be circular. The reflective surface 122 can be a unitary member or can be formed from two or more members arranged together to form the reflective surface 122 (e.g., an array of mirrors).

The base member 124 is secured to the terrestrial surface 108. In the example shown, the base member 124 is secured to the terrestrial surface by a concrete pad 132. A schematic representation of an azimuthal drive system 130 is shown that is configured to adjust the azimuth position of the reflective surface 122 by rotating the mirror about a vertical axis in the directions of the arrow 125. Although the azimuthal drive system 130 is shown at the bottom of the base member 124, in other implementations it may be closer to the mirror or otherwise positioned. A schematic representation of an elevational drive system 126 is shown that is configured to adjust the elevation position of the reflective surface 122 by rotating the mirror about an elevational axis. The elevational axis is a horizontal axis that is perpendicular to the azimuthal axis and that is directed into the page in this particular drawing. The elevational drive system 126 is configured to rotate the mirror about the elevational axis in the directions shown by the arrow 128. It should be understood that the example heliostat described above, including the azimuth and elevation kinematics, is but one example of a heliostat that can be used with the systems and techniques described herein. Differently configured heliostats, e.g., with different kinematics, can be used; the systems and techniques for determining the location of light reflected from the heliostats can be independent of a control system that controls movement of the reflective surfaces. Advantageously, the control system can use information determined over time about the location of the reflected light, e.g., to figure out the heliostat kinematics.

The controller 136 can be coupled to the azimuthal drive system 130 and the elevational drive system 126 and configured to provide signals to the drive systems 130, 126 to adjust the orientation of the reflective surface 122, e.g., to track relative movement of the Sun 102 and to correct for movement of the reflective surface 122 due to external forces, e.g., wind. The controller 136 can be located at the heliostat 120a as shown, or can be located remote from the heliostat 120a, but in communication with the azimuthal and elevational drive systems 130, 126, e.g., by wired or wireless communication.

To direct concentrated solar rays towards the target location within the aperture 110 for a particular heliostat, e.g., heliostat 120c, the normal vector of the reflective surface 152 ideally bisects the angle between the rays 145 from the Sun 102 and the ray 146 reflected toward the aperture 110. Thus, as the Sun 102 appears to move across the sky, the orientation of the reflective surface 152 must be adjusted to ensure that the reflected rays are hitting the target location without too much spillage, i.e., causing too many rays to be reflected outside of a target area.

The cameras 112-115 can be used to determine whether a particular reflective surface is oriented to reflect substantially the maximum amount of light onto the target location for the reflective surface. The cameras 112-115 are positioned within a same plane. In the example implementation shown, the plane of the cameras 112-115 is parallel to the virtual plane formed by the aperture 110. The plane that includes the cameras 112-115 is referred to herein as the target plane. There is a point within the target plane where the intensity of the sunlight reflected from a particular heliostat is maximized. That is, if the target plane is a physical plane, for example, in the example of a planar receiver surface, the sunlight reflected from a particular heliostat would project a “spot” (which can have a shape that varies with the shape of the reflective surface) of sunlight on the target plane.

A location of a point on the target plane where the intensity of the sunlight is maximized can be estimated. If the heliostat is on-target, then the location of the point is coincident with the desired location for the particular heliostat. If the heliostat is off-target, then the location of the point is not coincident with the target location and the orientation of the reflective surface of the heliostat can be adjusted so as to move the point back into a position that is coincident with the target location. Accordingly, by determining the location of the point, the amount by which to adjust the orientation of the heliostat's reflective surface can thereby be determined. Techniques are described herein where the location of the point within the target plane can be determined based on image information received from three or more view ports located within the target plane.

FIG. 2 is a schematic representation illustrating sunlight incident on a target plane 210. For illustrative purposes, a few representative rays of sunlight are shown incident on a reflective surface of a particular heliostat, which are reflected toward the target plane 210. In this example, the heliostat is heliostat 120a from FIG. 1 having a reflective surface 122. There are four cameras positioned within the target plane 210, being cameras 112-115 of FIG. 1. In this particular implementation, the cameras 112-115 are arranged in a ring within the target plane 210 that is substantially coincident with a plane of the aperture of the solar receiver, although it should be understood that other arrangements can be used. In some implementations, the cameras and/or the receiver may not physically lie within the aperture plane, but may be compensated mathematically to produce a result that is substantially the same as having cameras and/or the receiver positioned within the aperture plane. For example, the target plane 210 can be a predetermined distance away from the aperture plane, e.g., up to approximately 1 meter. In another example, the target plane 210 can be tilted at a predetermined angle relative to the aperture plane, e.g., up to approximately 10 degrees. Other configurations are possible.

In the illustrated example, scattering of light by matter suspended in the space between the Sun 102 and the heliostat 120a (e.g., atmospheric gasses, space debris, water vapor, atmospheric dust) creates the appearance of a “circumsolar disk” 202. The circumsolar disk 202 generally appears as a region of reflected solar energy that surrounds, but is less intense than, the Sun 102. The intensity of the circumsolar disk 202 generally appears greatest near the Sun 102 and appears to diminish in intensity with radial distance from the Sun 102.

Solar radiation from the Sun 102 (e.g., ray 105) and solar radiation from the circumsolar disk 202 (e.g., ray 203 and a ray 204), reflect off the reflective surface 122 and are reflected toward the target plane 210 as rays 106, 206 and 205 respectively. In general, rays from the Sun 102 (e.g., the ray 105) are reflected onto the target plane 210 to form a spot 220, and the rays 203, 204 from the circumsolar disk form a “halo” of lesser reflected intensity that surrounds the spot 220 and diminishes in intensity with radial distance from the center of the spot 220.

The cameras 112-115 capture images that include an image of the reflective surface 122, which surface 122 is reflecting rays from the Sun 102 and circumsolar disk 202 into the respective fields of view the cameras 112-115. For example, the camera 112 captures an image that includes a portion of the radiation from the circumsolar disk 202 represented by the example ray 205, and the camera 114 captures an image of another portion of the circumsolar disk 202 represented by the ray 206. As such, the images reflected by the surface 122 and captured by the cameras 112, 114 represent images captured in two fields of view of the same surface 122 at different reflected angles.

In some implementations, a polarizing filter placed in front of one or more of the cameras 112-115 can be adapted to alter the sunlight received by the cameras 112-115, e.g., to remove background images around the spot 220 received in the cameras' respective fields of view. In one example, cameras can be placed in physically proximate pairs, with the two members of a pair having polarization filters aligned orthogonally to each other. The difference between the two images from such a pair can highlight the heliostats in the cameras' fields of view. In another example, motorized rotating filters can be used on each camera, in which case the heliostats' brightnesses would vary periodically as the filters rotate. That is, polarizing filters may be rotatable about the cameras' fields of view to differentiate reflections from heliostats from light produced or reflected from other sources to aid in the discrimination of heliostats from other light sources. For example, reflected sunlight can exhibit a partly polarized property. When a polarized filter is rotated, the brightness of the sunlight reflected off a reflective surface can appear to vary relatively more than light produced by other sources (e.g., a beacon on a tower, city lights on the horizon, headlights from a nearby road).

FIG. 3 is a schematic representation showing an enlarged view of the target plane 210 of FIG. 2. For illustrative purposes, the representation shows an example reflection 300 of sunlight reflected onto the target plane 210 that includes the cameras 112-115. As mentioned above, the target plane 210 can be a virtual plane. However, for illustrative purposes, the example target plane 210 is shown with the example reflection 300 of sunlight represented as an image on the target plane 210, rather than sunlight passing through a virtual plane. The reflection 300 includes the spot 220 and regions 320, 321, 322, which represent sunlight reflected from the gradually radially reduced brightness of the circumsolar disk 202 of FIG. 2. As such, the lesser the distance (d1-d4) between the cameras 112-115 and the spot 220, the more intense (e.g., bright) an image of the reflected surface 122 in the field of view of a camera.

The centroid of the spot 220 is located on the target plane 210 at coordinates (x, y). The cameras 112-115 are located at distances (e.g., angular or linear distances) d1, d2, d3 and d4 respectively from the centroid and have coordinates represented by (x1, y1), (x2, y2), (x3, y3) and (x4, y4) respectively. Using a trilateration technique, the location of the centroid, i.e., coordinates (x,y) can be determined by solving the equations for each value of i below using the coordinates of each camera and its respective distance from the centroid.

(x−x₁)²+(y−yᵢ)²=d₁²

where i=1, 2, 3 or 4 for each of the four cameras

The system is over constrained since there are two unknowns, i.e., the coordinates x and y, but more than two equations, i.e., three or more corresponding to each of the three or more cameras. A method of least squares can be used to find a solution that minimizes the sum of the squares of the residuals, e.g. the expression shown below, to solve for x and y. That is, for each i=1, 2, 3, . . . , the i^{th} residual is determined using the expression below and the quantity to be minimized is the sum over i of the squares of these residuals:

\sqrt{(x−xᵢ)²+(y−yᵢ)²}−dᵢ

However, the distances from the centroid to the cameras are not known since the location of the centroid itself has not yet been determined. Accordingly, the intensity of reflected sunlight as seen by the field of view of a particular camera can be used as a proxy for the distance from the particular camera to the centroid. By using a relationship between the intensity of sunlight reflected by the heliostat as seen by a particular camera and an angular distance of the particular camera to the centroid of the spot, a location (i.e., x, y) on the target plane 210 of the spot 220 can be estimated. Below is an equation that can be used to determine x and y based on the intensity.

(x−xᵢ)²+(y−yᵢ)²=ƒ²(Iᵢ)

where ƒ(Iᵢ) is a function that relates intensity to distance

In some implementations, the relationship between intensity and distance can be estimated using a parametric relationship if a definite relationship is not known. For example, the function can be represented by a linear model as follows:

ƒ(Iᵢ)=A+B*Iᵢ

In other implementations, the function can be represented by a power law as follows:

ƒ(Iᵢ)=A*Iᵢ^{B}

In both example models, parameters A and B are variables and Iᵢ is the intensity as seen by the camera i (where i is an integer from 1−n and n is the number of cameras). Other example models can be used, and the ones shown are non-limiting examples for illustrative purposes. Using either of the above models introduces two more unknowns into the system, i.e., the parameters A and B. Accordingly, at least four cameras can be used such that there are at least four equations in the system that can be used to solve for the coordinates x and y and the two parameters A and B. In some implementations, A and B can be empirically estimated and equations can be used to solve for the coordinates x and y.

In some implementations, the coordinates for the centroid (x,y) and the parameters (e.g. A and B) can be estimated by performing a maximum likelihood estimation using the parametric model, e.g., the linear model or power law shown above. In other implementations, the parameters of a selected parametric model, e.g., constants A and B, can be estimated empirically, e.g., by experimentation. The location of the centroid, i.e., coordinates (x,y) can then be estimated based on the estimated values of A and B and the intensity values for each camera as determined from image information obtained from the cameras.

In some implementations, limits, e.g., bounds, can be placed on the parameters, which can be advantageous, e.g., if the optimization problem constructed would otherwise not have a unique solution. The limits can be in the form of ranges. In other implementations, one or more “penalty terms” can be added to the optimization objective function. For example, in the case of least squares fitting, the objective function is the sum of the squares of the residuals. In the case of maximum likelihood estimation, the objective function is a statistical likelihood function. The penalty terms can be chosen to grow with the variables (i.e., the coordinates x and y and the parameters) under consideration. In other implementations, a model can be chosen for which the optimization problem has a unique solution. As a simple example, the power law expression can be ƒ(Iᵢ) −A²*Iᵢ^{B}^{²}, such that the constant is always negative (or zero) and the exponent is always positive (or zero). Other techniques that someone skilled in the art of mathematical optimization could identify can be used to address the existence of a solution.

In some implementations, whether or not the centroid of the spot was locatable can be determined and reported. For example, the spot can be determined locatable if and only if: (1) a given function (e.g., the sum, minimum or maximum) or functions (e.g., the value of each of said functions) of the representative intensity values over all of the cameras exceeds a certain fixed, predetermined threshold (i.e., the spot is “bright enough”); and/or (2) some of all of the coordinates and parameters output by the optimization are within certain fixed, predetermined bounds (i.e., the solution found by algorithm is within a range designated as sensible).

In some implementations, the one or more parameters are one or more free parameters that are constrained. A constraint on a parameter can be within a range of values most recently computed for the parameter. In a particular example, one of the free parameters can represent solar irradiance and can be constrained to a function of a measurement of the solar irradiance, e.g., direct normal irradiance (DNI) measured with an instrument. If computed values for the free parameters are not within their respective constraints, then the values can be deemed not reliable and are not used to estimate the location of the point on the target plane. That is, by determining whether or not the computed free parameters are within their respective constraints, the system can be used detect that a heliostat is near enough on-target to reliably use the techniques described herein to track the pointing of the heliostat and/or can be used to detect that due to some event (e.g., a cloud or other disturbance) a heliostat's pointing is not reliably locatable by the system and techniques described herein.

To use intensity as seen in the field of view of a particular camera as a proxy for the distance from that camera to a centroid or to a point in a plane where intensity is maximized, intensity must be determined. Image information from the camera, e.g., camera 112, can be used to determine the intensity. In implementations where the image information is a pixelated image, a brightness, i.e., intensity, for the multiple pixels within the pixelated image can be determined. An image reflected from a particular heliostat will be represented by a subset of the total number of pixels. By way of illustrative example, image information for a pixel can be in the form of 8-bit integers for each color channel (of which there may be 3 channels). In some implementations, the pixel values can be averaged across the three channels and across the set of pixels that represent a heliostat. In other implementations, the pixel values can be summed over the three channels and the set of heliostat pixels. In other implementations the pixel values can be summed over the three channels and averaged over the set of heliostat pixels or visa versa. In other implementations a weighted average can be used.

In some implementations, intensity values associated with a reflective surface can be used to determine a mean pixel intensity, a weighted mean pixel intensity, an average pixel intensity, a weighted average pixel intensity, or other appropriate representative value that can be used to represent the overall received brightness of the sunlight reflected from the reflective surface as seen by a particular camera. For example, the intensity values of pixels determined to come from near the center of an image of the reflective surface may be given more mathematical weight than pixels from the edges of the image to determine a weighted mean or weighted average intensity value for the particular reflective surface. A representative intensity value can similarly be determined for the other three cameras 113-115, and this intensity information used in the system of equations above to estimate the location of the centroid for the particular reflective surface.

A computing system can be coupled to the cameras 112-115, for example, the computing system 190 shown in FIG. 1. In the example implementation shown, the computing system 190 is located at the receiver tower 106. However, it should be understood that in other implementations the computing system can be located elsewhere, for example, remote from the cameras 112-115 but communicatively coupled to the cameras, e.g., by a wired or wireless connection or otherwise, so as to receive image information from the cameras 112-115. Image information from the cameras 112-115 is transmitted to the computing system 190. The computing system 190 is configured to process the image information so as to determine the intensity of sunlight as seen by each camera as received from a particular heliostat. The computing system 190 is further configured to use the determined intensities to estimate the location of the centroid of sunlight in the target plane, for example, using the techniques described above.

In some implementations, the computing system 190 is further configured to compare the estimated location of the centroid to a known target location of the centroid and to determine what adjustments to the orientation of the reflective surface of the particular heliostat is required to make the actual location coincide with the target location, if the estimated location is not coincident with the target location. The computing system 190 can transmit information to a controller for the particular heliostat, e.g., controller 136 for heliostat 120a, such that the controller 136 can activate a drive system to re-orientate the reflective surface, e.g., the elevational drive system 126 and/or azimuthal drive system 130, so as to bring the heliostat 120a on target.

In some implementations, the controller 136 also activates the elevational drive system 126 and the azimuthal drive system 130 to adjust the orientation of the reflective surface 122 to account for relative movement of the Sun 102 to the heliostat 120a that occurs throughout the course of a day and throughout the days of the year. For example, by tracking the Sun 102 or using information that estimates the relative position of the Sun 102 and knowing the position of the heliostat 120a, the heliostat 120a can generally be kept on target. To account for unpredictable factors that can move the heliostat off-target, e.g., wind, the computing system 190 can use the information from the cameras 112-115 to further adjust the orientation of the reflective surface 122. Another unpredictable factor that can be accounted for is measurement error, e.g., errors in measuring the location of a heliostat in the field relative to the target; errors in the orientation of the field relative to true North; errors in the heliostat's intrinsic geometry and kinematics; and/or errors in the control of the heliostat's motor, to name a few.

Although the computing system 190 is shown as a single component in schematic representation of FIG. 1, it should be understood that the operations described above that are implemented by the computing system 190 can be implemented by more than one device, and which multiple devices can be located at more than one location. That is, the computing system 190 can be implemented as multiple processors at multiple locations, which may be local to the receiver tower 106 and/or remote.

In the example shown in FIG. 3, the spot 220 is located within a ring formed by the cameras 112-115. However, it should be understood that in some implementations, the techniques described above to determine the location of the centroid of the spot can be used even if the spot is outside a ring formed by the cameras 112-115. For example, if a particular heliostat was blown significantly off-target by a gust of wind and was reflecting sunlight toward a location away from the receiver, depending on how far away the centroid of the spot was relative to the cameras, the cameras 112-115 could still be used to estimate the location of the centroid. In some implementations, the effective distance is approximately two times the distance between the cameras. That is, if the cameras are positioned a radial distance of m from each other, then if the centroid of the spot is within a radial distance of two times m outside a ring formed by the cameras, then the spot can be locatable. As described above, typically multiple heliostats are arranged in a heliostat field and directed to reflect sunlight toward a receiver. That is, referring again to FIG. 1, multiple heliostats 120 are arranged about the receiver 104. As such, the cameras 112-115 receive sunlight reflected from multiple reflective surfaces of the multiple heliostats. A frame of image information from a particular camera therefore includes image information that relates to more than one heliostat. Various techniques can be used to identify which portion of the image information to attribute to which heliostat.

As described above, image information from a camera can be a pixelated image formed from an array of pixels, each having an intensity. An image reflected from a particular heliostat is represented by a subset of the total number of pixels. When the image includes reflected sunlight from multiple heliostats, the particular subsets of pixels to attribute to each of the multiple heliostats must be determined. Various techniques can be used to attribute a subset of the array of pixels to each of the multiple heliostats in a heliostat field, e.g., field 120, i.e., to calibrate the cameras 112-115.

In some implementations, during the calibration step, a camera, e.g., the camera 112, produces image information of the heliostat field 120. Portions of the image information, e.g., subsets of pixels, are assigned to each particular heliostat. In one embodiment, a particular heliostat, e.g., heliostat 120a, is directed to oscillate at a known frequency, e.g., by activating the elevational and/or azimuthal drive systems 126,130. The computing system 190 (or an operator thereof) can detect the frequency of blinking in the image information and can assign the corresponding pixels in the image information to the heliostat 120a. A similar process can occur for each of the heliostats 120 in the field until all of the heliostats have been assigned to a subset of pixels. The pixel/heliostat assigned is recorded and later used when determining the intensity as seen at a particular camera of sunlight reflected from a particular heliostat.

Because there are generally multiple heliostats 110 in a field, it may be advantageous to be able to detect when a heliostat is physically moved, or when a particular heliostat is added or removed from the field. Thus, in one embodiment, any new bright images that seem out of place may be compared with the original calibration image information to detect changes and to recalibrate as necessary.

In other implementations, fiducial markers can be positioned within the heliostat field 120 at known locations. A fiducial marker can be a bright beacon, e.g., a flag or paint mark, a light or flashing light, or other recognizable feature. Based on the known locations of the fiducial markers and known locations of the heliostats, image information that includes sunlight reflected from the heliostats and images of the fiducial markers, can be used to identify within an image which heliostats correspond to which known heliostat locations in the field. As such, a subset of pixels in an image can be identified and assigned to a particular heliostat for each of the multiple heliostats.

In other implementations, edge or feature detection can be used to identify a portion of an image that corresponds to a particular heliostat. For example, in a camera's field of view, the reflected sunlight from the heliostat 120a can be seen as a bright quadrilateral (or other shape). The multiple bright quadrilaterals within the image that correspond to the multiple heliostats can be identified within the image information by edge or feature detection techniques. The locations within the image of the identified quadrilaterals can be mapped to a known layout of the heliostats in the field 120. Based on the mapping, a subset of pixels that corresponds to a particular quadrilateral can be assigned to a particular heliostat for each of the heliostats.

The above calibration techniques are illustrative examples and other techniques can be used. For example, in some implementations, machine vision algorithms can be used to identify the heliostats as seen by the cameras using vision algorithms involving thresholding, clustering, bounding, known good location data, and/or combinations of these and other appropriate machine vision algorithms that someone skilled in the art of machine vision could identify. Calibration can occur once, periodically and/or continuously. For example, the cameras 112-115 are located on top of the tower 106 which can sway in the wind. Movement of the cameras 112-115 can be accounted for in re-calibration. The calibration steps can be carried out by the computing system 190 or another computing system that receives image information from the cameras 112-115.

When a heliostat field is operating under normal conditions, an active heliostat identification process can be undertaken. For example, the control system for the heliostats can be commanded to move the orientation of the reflective surfaces of a subset of the heliostats slightly in order to provide positive identification information, e.g., for calibrating or re-calibrating.

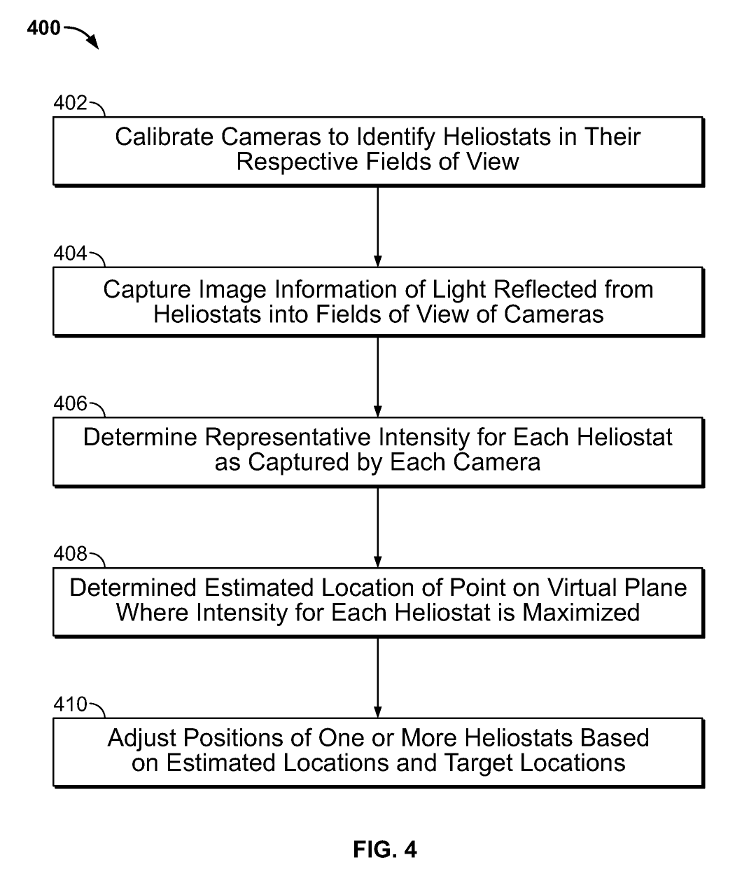

FIG. 4 is a flow chart that shows an example of a process 400 for using multiple cameras to locate reflected sunlight. It should be understood that the cameras can be optically connected to view ports as was discussed above. The process 400 is described for a system that includes multiple heliostats directed toward a receiver, although the process 400 can also be used in the case of a single heliostat. For illustrative purposes, the process 400 is described in terms of the system described above in reference to FIGS. 1-3, however, it should be understood that the process 400 can be implemented using a differently configured system.

The multiple cameras are calibrated to identify the multiple heliostats in their respective fields of view (402). For example, one or more of the techniques described above to identify a subset of pixels within a pixelated image that correspond to each heliostat can be used. If there is a single heliostat, then a single subset of pixels that corresponds to the image of the single heliostat can be identified.

Image information is captured of the light reflected from the multiple heliostats into the fields of view of the cameras (404). Based on the image information, a representative intensity is determined for each heliostat for each camera (406). For example, as described above, the image information from the cameras 112-115 can be transmitted to the computing system 190. The computing system 190 can determine the representative intensity for a particular heliostat, e.g., the mean intensity of the subset of pixels that are assigned to the particular heliostat.

For each heliostat, an estimated location of a point on a virtual plane (that includes the cameras) that is a function of the sunlight, e.g., where the intensity for the heliostat is maximized, is determined (408). As described above, the estimated location of the point on the virtual plane where the intensity is maximized for a particular heliostat can be determined based on the representative intensities determined for the heliostat and a relationship between intensity and distance from each camera to the location.

Orientations of reflective surfaces of one or more heliostats can be adjusted based on a comparison of the determined estimated locations that correspond to the heliostats and their respective target locations (410). For example, the computing system 190 can determine whether and how to adjust the orientation of a heliostat's reflective surface and transmit instructions to a controller for the heliostat, e.g., controller 136 for heliostat 120a. In response to the instructions, the controller 136 can activate the elevational and/or azimuthal drives systems 126, 130 for the heliostat to adjust the orientation of the reflective surface 122.

In some implementations, the process 400 can be performed by the computing system 190 and may or may not be performed in part by controllers associated with the heliostats, e.g., controller 136 for heliostat 120a, as described above.

In some implementations, for example if a field of heliostats is large, two or more sets of cameras can be used to capture image information from the heliostats. The two or more sets of cameras can be positioned in two or more different planes at two or more respective locations. The image information from the two or more sets of cameras can be used together to form a complete picture of the field, e.g., “stitched” together to form a large representative image of the field, or can be used independently.

The system described above is in the context of a reflective surface of a heliostat reflecting sunlight toward a receiver. It should be understood that the systems and techniques described can be used for other applications. That is, the systems and techniques can be used to determine a location on a virtual plane where an intensity of waves passing through the plane (or incident on the plane if a physical plane) is maximized. The three or more cameras can be replaced by three or more directionally-sensitive receivers. In other implementations, one or more of the directionally-sensitive receivers can be replaced by an array of uni-directional receivers. The three or more receivers can capture information about the waves within their field of reception. Based on representative intensities as determined from the captured information from the receivers and a relationship between the representative intensity (associated with a given receiver) and the distance between the given receiver and the spot of maximized intensity, the location of the spot of maximized intensity can be determined. For example, as discussed above in the context of heliostats, the relationship can be a parametric relationship that may be represented by a linear model or a power law, in some particular examples.

In the implementation described above, the waves are sunlight and the directionally-sensitive receivers that capture image information. In other implementations, the waves can be light waves (which may or may not be sourced from the Sun). In other implementations, the waves can be sound waves that are reflected off of a panel formed from a rigid material and the directionally-sensitive receivers can be audio receivers. In this implementation, the system can form a parabolic microphone. Other implementations are possible, and the ones described are illustrative, non-limiting examples.

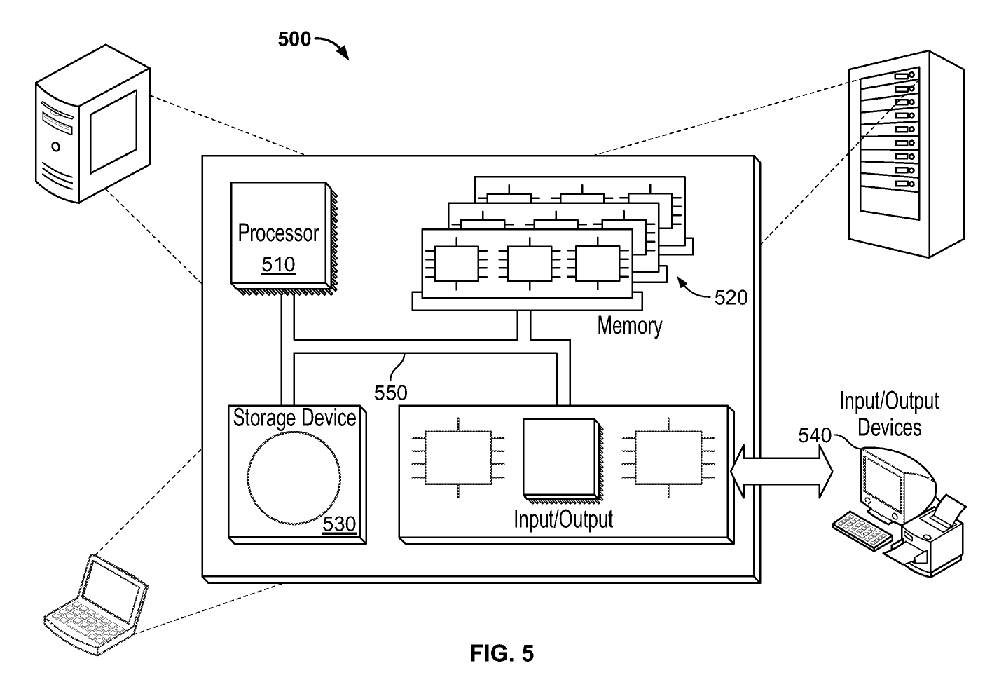

FIG. 5 is a schematic diagram of an example of a generic computer system 500. The system 500 can be used for the operations described in association with the process 400 according to one implementation. For example, the system 500 may be included in the computing system 190 and/or the controller 136 of FIG. 1.

The system 500 includes a processor 510 (which can be implemented two or more processors), a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
capturing image information of light reflected from a reflective surface with three or more view ports arranged in a configuration defining a target plane, wherein the three or more view ports are optically connected to one or more cameras; and
based on the image information and based on a relationship between intensity of light reflected by the reflective surface as captured by a particular view port and a distance of the particular view port to a point on the target plane that is a function of the light reflected from the reflective surface incident on or passing through the target plane, estimating a location on the target plane of the point.

2. The method of claim 1, wherein the point on the target plane is approximately a point on the target plane where the light reflected from the reflective surface incident on or passing through the target plane is maximized in intensity.

3. The method of claim 1, wherein the point on the target plane is approximately a centroid of the light reflected from the reflective surface incident on or passing through the target plane.

4. The method of claim 1, wherein estimating the location comprises performing least squares fitting.

5. The method of claim 1, wherein estimating the location comprises performing maximum likelihood estimation.

6. The method of claim 1, further comprising:
for each of the three or more view ports, determining from the respective captured image information a representative intensity of the reflected light as captured by the view port; and
wherein, estimating the location of the point based on the image information and based on the relationship comprises estimating the location of the point based on the representative intensities and based on the relationship.

7. The method of claim 6, wherein the relationship between intensity of light reflected by the reflective surface as captured by a particular view port and a distance of the particular view port to the point on the target plane includes one or more free parameters.

8. The method of claim 6, wherein the relationship between intensity of light reflected by the reflective surface as captured by a particular view port and a distance of the particular view port to the point on the target plane is a power law relationship.

9. The method of claim 6, wherein the relationship between intensity of light reflected by the reflective surface as captured by a particular view port and a distance of the particular view port to the point on the target plane is a linear relationship.

10. The method of claim 6, wherein the representative intensity of reflected light as captured by each of the three or more view ports comprises a mean intensity of the image information for the reflected light.

11. The method of claim 6, wherein the representative intensity of reflected light as captured by each of the three or more view ports comprises a weighted mean intensity of the image information for the reflected light.

12. The method of claim 1, further comprising:
comparing the estimated location of the point to a desired location in the plane; and
adjusting an orientation of the reflective surface based on the comparison.

13. The method of claim 1, wherein the light is sunlight and the reflective surface is included in a heliostat and the reflective surface is configured to reflect the sunlight toward a solar energy receiver.

14. The method of claim 13, wherein the target plane is a plane that is coincident with a plane that includes an aperture of the solar energy receiver, through which the reflected sunlight passes into a solar energy receiving cavity.

15. The method of claim 13, wherein the target plane is a plane that is a predetermined distance away from a plane that includes an aperture of the solar energy receiver, through which the reflected sunlight passes into a solar energy receiving cavity.

16. The method of claim 13, wherein the target plane is a plane that is a predetermined angle relative to a plane that includes an aperture of the solar energy receiver, through which the reflected sunlight passes into a solar energy receiving cavity.

17. A method comprising:
identifying each of a plurality of heliostats in a field of view of each of a plurality of view ports that are receiving sunlight reflected from the plurality of heliostats at a target plane wherein the plurality of view ports are arranged in the target plane;
capturing image information of sunlight reflected from reflective surfaces of the plurality of heliostats and received at the target plane with the plurality of view ports that are optically connected to one or more cameras; and
estimating for each heliostat a location of a point on the target plane based on the image information and based on a relationship between intensity of light reflected by the reflective surface of the heliostat as captured by a particular view port and a distance of the particular view port to a point on the target plane that is a function of the light reflected from the reflective surface incident on or passing through the target plane.

18. The method of claim 17, wherein for each heliostat the point on the target plane is approximately a point on the target plane where the sunlight reflected from the reflective surface of the heliostat and incident on or passing through the target plane is maximized in intensity.

19. The method of claim 17, wherein for each heliostat the point on the target plane is approximately a centroid of the light reflected from the reflective surface incident on or passing through the target plane.

20. The method of claim 17, wherein estimating the location based on the image information and the relationship comprises performing least squares fitting.

21. The method of claim 17, wherein estimating the location based on the image information and the relationship comprises performing maximum likelihood estimation.

22. The method of claim 17, further comprising:
determining from the image information a representative intensity of each heliostat as captured by each view port; and
wherein estimating the location of the point based on the image information and based on the relationship comprises estimating the location of the point based on the representative intensities and based on the relationship.

23. The method of claim 22, wherein the relationship between intensity of light reflected by the reflective surface as captured by a particular view port and a distance of the particular view port to the point on the target plane includes one or more free parameters.

24. The method of claim 22, wherein the relationship between intensity of light reflected by the reflective surface as captured by a particular view port and a distance of the particular view port to a point on the target plane is a power law relationship.

25. The method of claim 22, wherein the relationship between intensity of light reflected by the reflective surface as captured by a particular view port and a distance of the particular view port to a point on the target plane is a linear relationship.

26. The method of claim 22, wherein the representative intensity of reflected sunlight as captured by each of the three or more view ports comprises a mean intensity of the image information for the reflected sunlight.

27. The method of claim 22, wherein the representative intensity of reflected sunlight as captured by each of the three or more view ports comprises a weighted mean intensity of the image information for the reflected sunlight.

28. The method of claim 17, further comprising, for each of one or more of the heliostats:
comparing the estimated location of the point to a desired location in the plane; and
adjusting an orientation of the reflective surface of the heliostat based on the comparison.

29. The method of claim 17, wherein the reflective surface of each heliostat is configured to reflect the sunlight toward a solar energy receiver and the target plane is a plane that is coincident with a plane that includes an aperture of the solar energy receiver, through which the reflected sunlight passes into a solar energy receiving cavity.

30. The method of claim 17, wherein the reflective surface of each heliostat is configured to reflect the sunlight toward a solar energy receiver and the target plane is a plane that is a predetermined distance away from a plane that includes an aperture of the solar energy receiver, through which the reflected sunlight passes into a solar energy receiving cavity.

31. The method of claim 17, wherein the reflective surface of each heliostat is configured to reflect the sunlight toward a solar energy receiver and the target plane is a plane that is a predetermined angle relative to a plane that includes an aperture of the solar energy receiver, through which the reflected sunlight passes into a solar energy receiving cavity.

32. A system comprising:
a reflective surface configured to reflect light to a target plane;
three or more view ports arranged in the target plane, each view port having a field of view configured to receive reflected light from the reflective surface and optically connected to a camera;
at least one camera optically connected to one or more of the three or more view ports; and
a computing system coupled to the at least one camera and configured to:
receive image information from the at least one camera that is captured by the three or more view ports; and
based on the image information and a relationship between intensity of light reflected by the reflective surface as captured by a particular view port and a distance of the particular view port to a point on the target plane that is a function of light reflected from the reflective surface incident on or passing through the target plane, estimate a location on the target plane of the point.

33. The system of claim 32, further comprising:
an actuator system communicatively coupled to the computing system and configured to move the reflective surface to adjust an orientation of the reflective surface based on the estimated location on the target plane of the point as compared to a target location on the target plane.

34. The system of claim 32, wherein the light is sunlight and the reflective surface is included in a heliostat, the system further comprising:
a solar energy receiver, wherein the target plane is a plane that is coincident with a plane that includes an aperture of the solar energy receiver, through which the reflected sunlight passes into a solar energy receiving cavity and wherein and the reflective surface is orientated to reflect the sunlight toward the solar energy receiver.

35. The system of claim 32, wherein the light is sunlight and the reflective surface is included in a heliostat, the system further comprising:
a solar energy receiver, wherein the target plane is a plane that is a predetermined distance away from a plane that includes an aperture of the solar energy receiver, through which the reflected sunlight passes into a solar energy receiving cavity.

36. The system of claim 32, wherein the light is sunlight and the reflective surface is included in a heliostat, the system further comprising:
a solar energy receiver, wherein the target plane is a plane that is a predetermined angle relative to a plane that includes an aperture of the solar energy receiver, through which the reflected sunlight passes into a solar energy receiving cavity.

37. The system of claim 32, wherein the point on the target plane is approximately a point on the target plane where the light reflected from the reflective surface incident on or passing through the target plane is maximized in intensity.

38. The system of claim 32, wherein the point on the target plane is approximately a centroid of the light reflected from the reflective surface incident on or passing through the target plane.

39. The system of claim 32, wherein the computing system that is configured to estimate the location is configured to perform maximum likelihood estimation.

40. The system of claim 32, wherein the computing system that is configured to estimate the location is configured to perform least squares fitting.

41. The system of claim 32, wherein the relationship between intensity of light reflected by the reflective surface as captured by a particular view port and a distance of the particular view port to the point on the target plane includes one or more free parameters.

42. The system of claim 32, wherein the relationship between intensity of light reflected by the reflective surface as captured by a particular view port and a distance of the particular view port to a point on the target plane is a power law relationship.

43. The system of claim 32, wherein the relationship between intensity of light reflected by the reflective surface as captured by a particular view port and a distance of the particular view port to a point on the target plane is a linear relationship.

44. The system of claim 32, wherein the computing system is further configured to:
based on the image information, determine for each of the three or more view ports a representative intensity of reflected light as captured by each of the three or more view ports;
wherein, estimating the location of the point based on the image information and based on the relationship comprises estimating the location of the point based on the representative intensities and based on the relationship.

45. The system of claim 44, wherein the representative intensity of reflected light as captured by each of the three or more view ports comprises a mean intensity of the image information for the reflected light.

46. The system of claim 44, wherein the representative intensity of reflected light as captured by each of the three or more view ports comprises a weighted mean intensity of the image information for the reflected light.

47. A system comprising:
a plurality of heliostats, each heliostat including a reflective surface configured to reflect sunlight to a target plane;
three or more view ports arranged in the target plane, each view port having a field of view configured to receive reflected sunlight from the reflective surfaces of the plurality of heliostats and optically connected to a camera;
at least one camera optically connected to one or more of the three or more view ports; and
a computing system coupled to the at least one camera and configured to:
receive image information from the at least one camera and captured by the three or more view ports;
identify each of the plurality of heliostats in a field of view of each of the three or more view ports; and
for each of the plurality of heliostats, based on the image information and a relationship between intensity of sunlight reflected by the heliostat as captured by a particular view port and a distance of the particular view port to a point on the target plane that is a function of sunlight reflected from the heliostat incident on or passing through the target plane, estimate a location on the target plane of the point.

48. The system of claim 47, further comprising:
a plurality of actuator systems that each correspond to one of the plurality of heliostats, each actuator system communicatively coupled to the computing system and configured to move the reflective surface of the corresponding heliostat to adjust an orientation of the reflective surface based on the estimated location on the target plane of the point as compared to a target location on the target plane.

49. The system of claim 47, further comprising:
a solar energy receiver, wherein the target plane is a plane that is coincident with a plane that includes an aperture of the solar energy receiver, through which the reflected sunlight passes into a solar energy receiving cavity and wherein and the reflective surfaces are orientated to reflect the sunlight toward the solar energy receiver.

50. The system of claim 47, further comprising:
a solar energy receiver, wherein the target plane is a plane that is a predetermined distance away from a plane that includes an aperture of the solar energy receiver, through which the reflected sunlight passes into a solar energy receiving cavity.

51. The system of claim 47, further comprising:
a solar energy receiver, wherein the target plane is a plane that is a predetermined angle relative to a plane that includes an aperture of the solar energy receiver, through which the reflected sunlight passes into a solar energy receiving cavity.

52. The system of claim 47, wherein the point on the target plane is approximately a point on the target plane where the sunlight reflected from the reflective surface incident on or passing through the target plane is maximized in intensity.

53. The system of claim 47, wherein the point on the target plane is approximately a centroid of the light reflected from the reflective surface incident on or passing through the target plane.

54. The system of claim 47, wherein the computing system that is configured to estimate the location based on the image information and the relationship comprises a computing system that is configured to perform maximum likelihood estimation.

55. The system of claim 47, wherein the computing system that is configured to estimate the location based on the image information and the relationship comprises a computing system that is configured to perform least squares fitting.

56. The system of claim 47, wherein the relationship between intensity of light reflected by the reflective surface as captured by a particular view port and a distance of the particular view port to a point on the target plane includes one or more free parameters.

57. The system of claim 47, wherein the relationship between intensity of light reflected by the reflective surface as captured by a particular view port and a distance of the particular view port to a point on the target plane is a power law relationship.

58. The system of claim 47, wherein the relationship between intensity of light reflected by the reflective surface as captured by a particular view port and a distance of the particular view port to a point on the target plane is a linear relationship.

59. The system of claim 47, wherein the computing system is further configured to:
based on the image information and for each of the plurality of heliostats, determine for each of the three or more view ports a representative intensity of sunlight reflected from the heliostat and captured by each of the three or more view ports.

60. The system of claim 59, wherein the representative intensity for each heliostat of reflected sunlight as captured by each of the three or more view ports comprises a mean intensity of the image information for the reflected sunlight.

61. The system of claim 59, wherein the representative intensity for each heliostat of reflected sunlight as captured by each of the three or more view ports comprises a weighted mean intensity of the image information for the reflected sunlight.
